(19) United States
(12) Patent Application Publication
(10) Pub. No.: US 2023/0359681 A1
(43) Pub. Date: Nov. 9, 2023

(54) TRUE ATTRIBUTION

(71) Applicant: Meta Platforms, Inc., Menlo Park, CA (US)

(72) Inventors: Mihir Gogate, San Francisco, CA (US); Sulman Choudhry, San Carlos, CA (US); Kirollos Risk, Walnut Creek, CA (US); Mark Kizelshteyn, Brooklyn, NY (US)

(21) Appl. No.: 17/735,416

(22) Filed: May 3, 2022

(51) Int. Cl. G06F 16/9536; G06F 16/9538; G06F 16/44; G06Q 50/00

(52) U.S. Cl. CPC G06F 16/9536; G06F 16/9538; G06F 16/447; G06Q 50/01

(57) ABSTRACT

Methods, systems, and storage media for attributing origination to content creators are disclosed. Exemplary implementations may: determine whether content created by a user is original; in response to determining that the content is original, track the content created by the user through the social media platform; determine whether other users have leveraged the at least one attribute of the content; in response to determining that at least one other user has leveraged the at least one attribute of the content, generate a metric that represents a popularity of the at least one attribute of the content; update the popularity of the at least one attribute of the content; and cause display of the metric through a user interface of the social media platform.

### TECHNICAL FIELD

The present disclosure generally relates to attribution in social media platforms and more particularly to attributing origination to true content creators.

### BACKGROUND

Audio, video, and other content is readily distributed via social media. Indeed, social media has become a major source for original content in today's culture. Influencers and even big-name stars often pick up original content and redistribute it in its original form or by adding their own twist. The original content and mutations of the content can be quickly amplified and spread on the same social media platform or even across different channels, including more traditional distribution channels such as radio, print, and television.

Some content that originates on social media even rises to the level of being trendsetting. For example, an individual dancer may come up with a unique dance move and upload a video recording to a social media platform. That video may be picked up by the dancer's circle of friends, and perhaps even an influencer in the online dance realm. The influencer may post the video on their social media account, where it is seen by a television talk show host who then performs the dance on their television show. Instantly, the dance move is a hit and people around the world are performing the dance move.

### BRIEF SUMMARY

The subject disclosure provides for systems and methods for attribution in social media platforms. According to aspects, a user is allowed to find at least one attribute in propagated content (e.g., trending content on social media) to reveal the original creator of that content. For example, a video clip that has been leveraged and evolved through multiple iterations, and even shared across different platforms before going viral, can still be tracked back and attributed to the original content creator.

One aspect of the present disclosure relates to a method for attributing origination to content creators. The method may include determining whether content created by a user is original. The content may include at least one attribute. The content may be generated through a social media platform. The method may include, in response to determining that the content is original, tracking the content created by the user through the social media platform. The method may include determining whether other users have leveraged the at least one attribute of the content. The method may include, in response to determining that at least one other user has leveraged the at least one attribute of the content, generating a metric that represents a popularity of the at least one attribute of the content. The method may include updating the popularity of the at least one attribute of the content. The method may include causing display of the metric through a user interface of the social media platform.

Another aspect of the present disclosure relates to a system configured for attributing origination to content creators. The system may include one or more hardware processors configured by machine-readable instructions. The processor(s) may be configured to determine whether content created by a user is original. The content may include at least one attribute. The content may be generated through a social media platform. The processor(s) may be configured to, in response to determining that the content is original, track the content created by the user through the social media platform. The processor(s) may be configured to determine whether other users have leveraged the at least one attribute of the content. The processor(s) may be configured to, in response to determining that at least one other user has leveraged the at least one attribute of the content, generate a metric that represents a popularity of the at least one attribute of the content. The processor(s) may also be configured to determine whether other users have leveraged the at least one attribute of the content, the at least one attribute tracking the content as the content is leveraged so that origination of the content is attributable back to the user. The processor(s) may be configured to update the popularity of the at least one attribute of the content. The processor(s) may be configured to cause display of the metric through a user interface of the social media platform.

Yet another aspect of the present disclosure relates to a non-transient computer-readable storage medium having instructions embodied thereon, the instructions being executable by one or more processors to perform a computer-implemented method for attributing origination to content creators. The method may include determining whether content created by a user is original. The content may include at least one attribute. The content may be generated through a social media platform. The method may include, in response to determining that the content is original, tracking the content created by the user through the social media platform. The method may include assigning attribution of the original content based on determining a level of confidence that the content is from the user. The method may also include tracking the content and mutations of the content over time. The method may also include tracking different media that the original content and the mutations of the content are used in. The method may include determining whether other users have leveraged the at least one attribute of the content. The method may include, in response to determining that at least one other user has leveraged the at least one attribute of the content, generating a metric that represents a popularity of the at least one attribute of the content. The method may include updating the popularity of the at least one attribute of the content. The method may include causing display of the metric through a user interface of the social media platform.

Still another aspect of the present disclosure relates to a system configured for attributing origination to content creators. The system may include means for determining whether content created by a user is original. The content may include at least one attribute. The content may be generated through a social media platform. The system may include means for, in response to determining that the content is original, tracking the content created by the user through the social media platform. The system may include means for determining whether other users have leveraged the at least one attribute of the content. The system may include means for, in response to determining that at least one other user has leveraged the at least one attribute of the content, generating a metric that represents a popularity of the at least one attribute of the content. The system may include means for updating the popularity of the at least one attribute of the content. The system may include means for causing display of the metric through a user interface of the social media platform.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example user's profile showing a metric for creators to accrue value for inspiring and propagating ideas, according to certain aspects of the disclosure.

FIG. 2 illustrates an example of an aggregation space or discovery surface, according to certain aspects of the disclosure.

FIG. 3 illustrates an example tab in the discovery surface revealing original content or attributes that a creator has introduced, according to certain aspects of the disclosure.

FIG. 4 illustrates an example pivot page of an attribute, according to certain aspects of the disclosure.

FIGS. 5 and 6 illustrate an example trend timeline showing trend lineage of the attribute, according to certain aspects of the disclosure.

FIG. 7 illustrates an example Non-Fungible Token (NFT) structure, according to certain aspects of the disclosure.

FIG. 8 illustrates a system configured for attribution in social media platforms, in accordance with one or more implementations.

FIG. 9 illustrates an example flow diagram for attribution in social media platforms, according to certain aspects of the disclosure.

FIG. 10 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Social media influencers and big-name stars often get outsized credit for simply amplifying content that they did not create. In the example of the television star who performed the dance move on their television show, most of the viewers may assume that he or she created the dance move. The television star may be credited by most people as having originated the latest dance trend. Unfortunately, the original creator may often be forgotten and given little of any attribution for their work or for inspiring others.

The subject disclosure provides for systems and methods for attribution in social media platforms. A user is allowed to track changes to original content over time, even across different social media platforms, and still give origination credit to the creator of the original content. For example, original content that has evolved over time and been picked up and propagated by others, including social media influencers and amplifiers who outsize the impact of that content, can still be tracked back to the creator of the original content.

Implementations described herein address the aforementioned shortcomings and other shortcomings by providing a metric for creators to accrue value for inspiring and propagating ideas. In exemplary implementations, clicking or tapping the metric on a user's profile may navigate to a discovery surface. A tab in the discovery surface may reveal original content or “attributes” that a creator is responsible for introducing. Selecting an attribute may display a pivot page that aggregates content leveraging the attribute. A trend timeline may show trend lineage (e.g., how a trend grew) and may feature the originators, amplifiers who helped spread the trend, and rising stars who participated such that it can be seen how cultural movements spread and credit or “true attribution” is given to the creators.

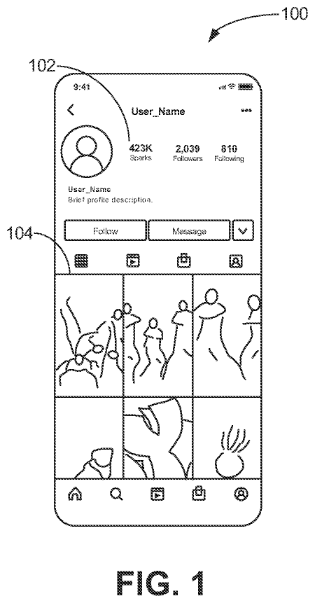

FIG. 1 illustrates an example user's profile 100 showing a metric for creators to accrue value for inspiring and propagating ideas, according to certain aspects of the disclosure. In an example, the user's profile may include a metric (the number of “sparks”) 102 for original content. Original content of the user may be displayed, e.g., as tiles 104 on the user's profile 100. The metric 102 enables creators to accrue value for inspiring and propagating ideas, even after those ideas have been picked up by others, changed, and spread across social media and even into traditional media (e.g., television). Tapping the metric 102 on a user's profile 100 navigates to a discovery surface.

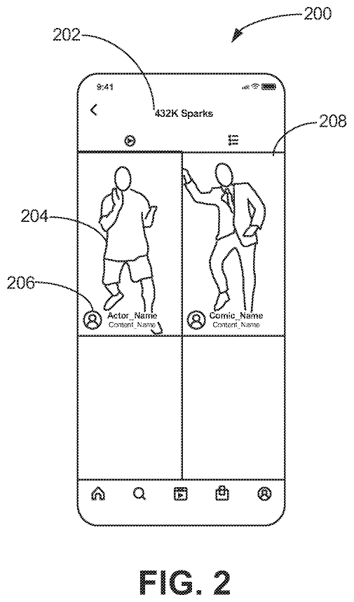

FIG. 2 illustrates an example of an aggregation space or discovery surface 200, according to certain aspects of the disclosure. The discovery surface 200 shows the metric 202, and displays content, for example, as tiles 204. The tiles 204 may represent reels, videos and stories based on the creator's original content. Also included on the tiles 204 may be the user name and the attributed created tool 206. Users may also pin their favorites by selecting the pin button 208.

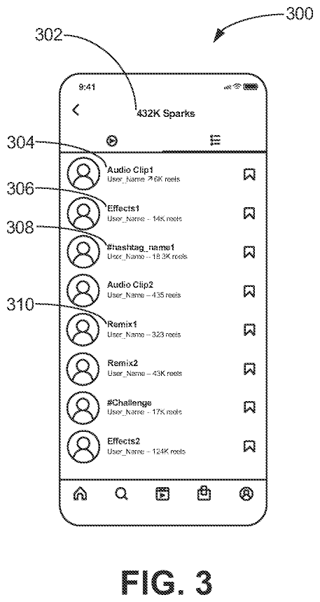

FIG. 3 illustrates an example tab 300 in the discovery surface (e.g., FIG. 2) revealing original content or attributes that a creator has introduced, according to certain aspects of the disclosure. The metric 302 may be displayed, along with attributes that may include by way of illustration, audio clips 304, effects 306, tags/challenges 308, and remixes 310. Selecting an attribute displays a pivot page that aggregates content that leveraged the attribute.

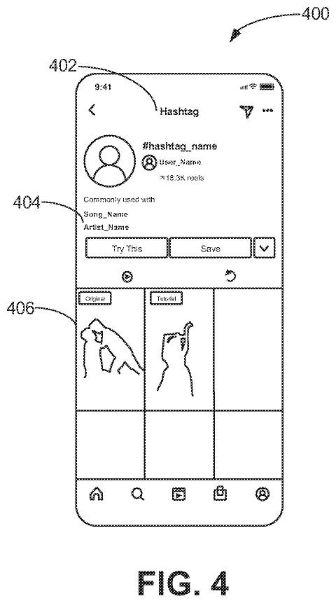

FIG. 4 illustrates an example pivot page 400 of an attribute, according to certain aspects of the disclosure. In this example, the attribute 402 selected is the Hashtag 404 for “Aurora.” Tiles 406 are displayed showing all content for the user that includes the Hashtag 404 for “Aurora,” regardless of the social media channel or platform that it has been distributed on.

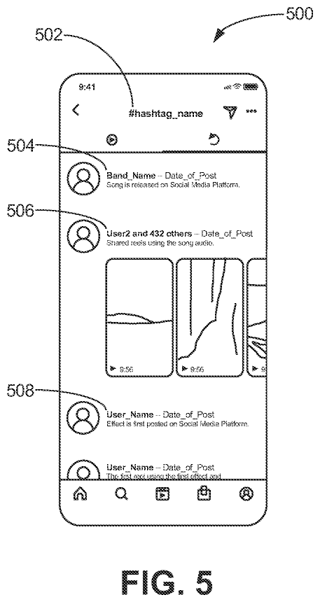

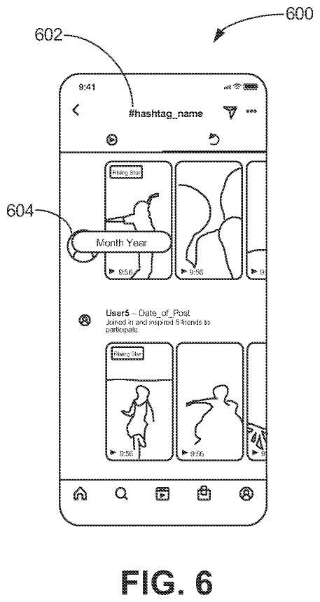

FIGS. 5 and 6 illustrate an example trend timeline showing trend lineage of the attribute, according to certain aspects of the disclosure. In FIG. 5, the trend timeline 500 displays the Hashtag 502 “runawayaurora” and displays all variations of the original content including that Hashtag 502. In this example, the original release 504 is displayed, along with shares, mutations and other instances of the media 506 and 508.

In FIG. 6, the trend timeline 600 displays the Hashtag 602 “runawayaurora” and all variations of the original content as it has evolved over time 604. The user can scroll forward and backward in time to see variations and propagations of the original content following its release.

A trend timeline shows trend lineage (e.g., how a trend grew), and features the originators, amplifiers who helped spread the trend, and rising stars who participated. Hence it can be seen how cultural movements spread, and gives credit or “true attribution” to the creators.

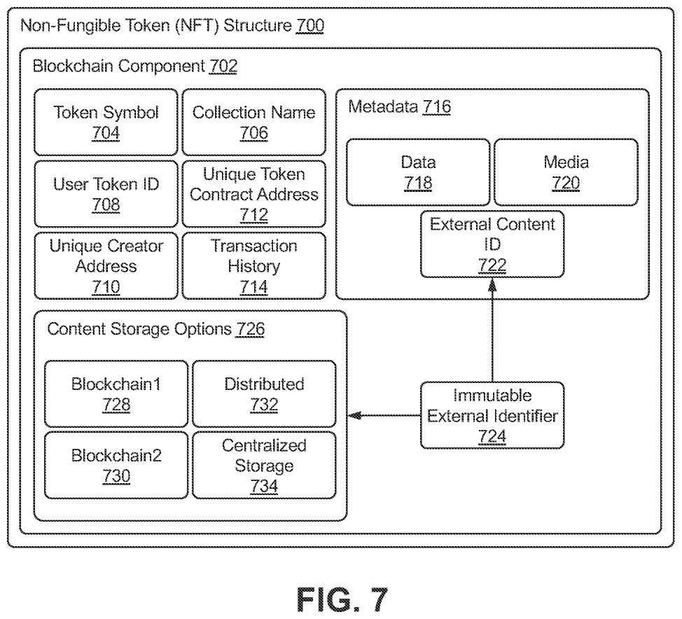

FIG. 7 illustrates an example Non-Fungible Token (NFT) structure 700, according to certain aspects of the disclosure. The NFT 700 is a data structure which may be constructed, initiated, and maintained/loaded with data. The NFT 700 enables users to build real-world value based on their online content contributions. For example, a user who creates or is constructively involved in the mutation and/or perpetuation of original content, may receive credit that can accrue value (e.g., for trade or even monetized).

The NFT structure 700 may include a blockchain component 702. The blockchain component 702 may include a token symbol 704 for a collection name 706 corresponding to content of the user. The NFT 700 may include a unique token ID 708, a unique creator address 710, a unique token contract address 712, and a transaction history 714 corresponding to the user and the user's content.

The NFT structure 700 may also include metadata 716. Metadata may include data 718, media 720, and external content ID 722.

The NFT structure 700 may also communicate via an immutable external identifier 724 with content storage options 726. Content storage options 726 may include blockchains 728 and 730, distributed storage 732, and centralized storage 734.

The disclosed system(s) address a problem in traditional attribution techniques in social media platforms tied to computer technology, namely, the technical problem of attributing contributions to content that gets shared on social media and other sharing platforms (e.g., including traditional media), and often changes or evolves over time. The disclosed system solves this technical problem by providing a solution also rooted in computer technology, namely, by providing for attributing origination to true content creators. The disclosed subject technology further provides improvements to the functioning of the computer itself because it improves processing and efficiency in attribution in social media platforms.

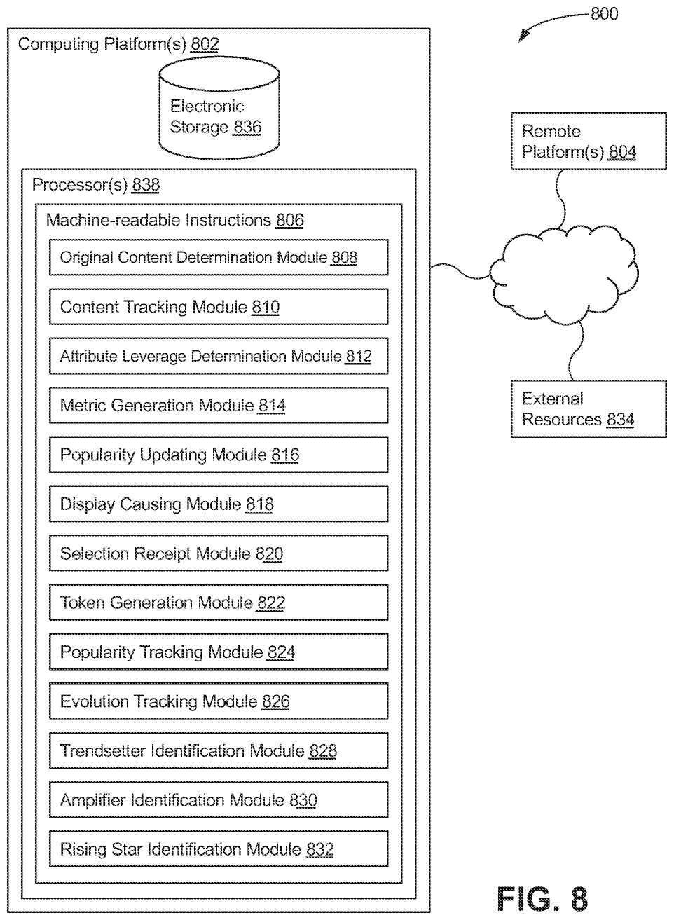

FIG. 8 illustrates a system 800 configured for attribution in social media platforms, according to certain aspects of the disclosure. In some implementations, system 800 may include one or more computing platforms 802. Computing platform(s) 802 may be configured to communicate with one or more remote platforms 804 according to a client/server architecture, a peer-to-peer architecture, and/or other architectures. Remote platform(s) 804 may be configured to communicate with other remote platforms via computing platform(s) 802 and/or according to a client/server architecture, a peer-to-peer architecture, and/or other architectures. Users may access system 800 via remote platform(s) 804.

Computing platform(s) 802 may be configured by machine-readable instructions 806. Machine-readable instructions 806 may include one or more instruction modules. The instruction modules may include computer program modules. The instruction modules may include one or more of original content determination module 808, content tracking module 810, attribute leverage determination module 812, metric generation module 814, popularity updating module 816, display causing module 818, selection receipt module 820, token generation module 822, popularity tracking module 824, evolution tracking module 826, trendsetter identification module 828, amplifier identification module 830, rising star identification module 832, and/or other instruction modules.

Original content determination module 808 may be configured to determine whether content created by a user is original. The content may be generated through a social media platform. By way of non-limiting example, the content may include a media type comprising at least one of a reel, video, story, photo, product, advertisement, or branded content. The content may include at least one attribute. The at least one attribute may track units of creation in leveraged content that are attributed back to the content creator.

The content may include any media type. Content is not limited to online creations. For example, content may include a live performance that is recorded and then uploaded. In addition, a single piece of content may include multiple types of media, such as video, audio, and text.

Any attribute may be implemented to track units of creation. Content may have more than one attribute. Some attributes may be separated or even lost entirely as the content evolves over time. For example, content may include an audio recording of a live performance of a song that is used as background for a music video. A particular scene in the music video may gain appeal, and be reworked into content that is then set to a different soundtrack, and it is this modified content that then ends up getting shared and “goes viral.” Attributes of the original music video pertaining only to that segment of the video that is included in the modified content would still be tracked. However, tracking this attribute would still serve to credit the original creator, even though some attributes of the original content have been lost/removed during the evolution on the content.

Content tracking module 810 may be configured to, in response to determining that the content is original, track the content created by the user through the social media platform. In some implementations, a number of media may be tracked in which the original content has been used. In an example, the content tracking module 810 may assign at least one attribute so that the content can be tracked. These attributes may be tracked across multiple social media platforms, including across different types of platforms (e.g., traditional media such as television). In an example, the attributes may even extend offline (e.g., via Hashtag tracking at a live event).

Attribute leverage determination module 812 may be configured to determine whether other users have leveraged the at least one attribute of the content. By way of non-limiting example, the attribute may include at least one of audio, effect, remix, hashtag, and challenge.

An audio attribute may indicate a type of audio (e.g., song, transcript) and even subtypes (e.g., instrumental or vocal). An effect attribute may indicate a special effect that has been applied to the content, such as comedic narration of a video segment that formed the original content. A remix attribute may indicate that the original content has been changed according to genre. For example, a classical music piece may be “remixed” as a rap or hip-hop song. A hashtag attribute indicates that the content is being shared and identified by hashtag. Hashtags often serve to identify events by category defined by the hashtag. For example, all songs by a particular artist may include a hashtag of the artist's name. A challenge attribute may indicate a “viral challenge” such as the “ugly baby” challenge which had parents sharing photos of their newborn babies. Still other attributes may be implemented and are not limited to those listed herein.

Metric generation module 814 may be configured to, in response to determining that at least one other user has leveraged the at least one attribute of the content, generate a metric that represents a popularity of the at least one attribute of the content. In an example, the metric is referred to as a “spark.” The more “sparks” a content creator is attributed, the more the content creator has initiated content that spread and influenced social media and even popular culture. This metric can be used by the content creator to increase their visibility, gain credit, and even be monetized.

Popularity updating module 816 may be configured to update the popularity of the at least one attribute of the content. As content is shared, it may gain or lose in popularity. For example, if a piece of content (or derivation of the content) is shared on a popular television show, it may instantly gain in popularity. Other content may, over time, lose in popularity.

Display causing module 818 may be configured to cause display of the metric through a user interface of the social media platform. This display allows the content creator to receive credit for their contribution(s). Displaying the metric can help the content creator to increase their visibility, gain credit, and even be monetized.

Display causing module 818 may be configured to cause display of content that causes a trend in a trend tab. The attribute may be displayed in a separate tab from the trend tab. It is noted that while the term “tab” is used herein, the display is not limited to any particular format or method of access.

Selection receipt module 820 may be configured to receive a selection of an attribute by the user. When the user searches for an origination of a particular piece of content, this allows the user to see versions of the content that point back to an originating content.

Display causing module 818 may be configured to cause display of a pivot page based on the selection. The pivot page may display trending content that leverages the selected attribute. The term “pivot page” is used herein to refer to a display of the content over time. However, the disclosure herein is not limited to any particular type of output. In an example, the pivot page may include a trend timeline. The trend timeline may include trending content. The trend timeline may display growth of the attribute. The trend timeline thus enables users to see the evolution of content over time, including where that content has spread and how it has changed.

Display causing module 818 may be configured to cause display of one or more of trendsetters, amplifiers, and/or rising stars. The trendsetters may include originators of a trend comprising at least one attribute. The amplifiers may include users that have a large impact on spreading the trend. The rising stars may include small-sized creators.

Token generation module 822 may be configured to generate a Non-Fungible Token (NFT) based on the attribute.

Popularity tracking module 824 may be configured to track the popularity of the attribute through a blockchain of the NFT.

Display causing module 818 may be configured to, in response to the user making a selection from the at least one attribute, cause display of a pivot page with an aggregate of propagated content created leveraging the selected attribute to give credit to the content creator. Credit may be given to the content creator by assigning a Non-Fungible Token (NFT) to the content creator. Displaying the aggregate of the propagated content on the pivot page may be on a content grid. Displaying the aggregate of the propagated content on the pivot page may be on a composite space. Displaying the aggregate of the propagated content on the pivot page may be on a trend timeline. The trend timeline may show an evolution of a trend.

Evolution tracking module 826 may be configured to track evolution of content and giving origination credit to an originator and giving contribution credit to contributors. Content may change as it is shared. For example, someone may see the original content (e.g., a photograph of a cityscape) and simply share it. Someone else who sees the shared content may add a quote or commentary on the media and reshare it. An influencer may add a soundtrack and share the content to a very large audience, at which time it gets picked up by a television show host, who shows the photo as the soundtrack is playing on the television show. Each of these changes can be tracked and the original content attributed back to the original content creator.

Trendsetter identification module 828 may be configured to identify a trendsetter that starts a trend based on the original content. A “trendsetter” as the term is used herein, may be an original content creator, or someone who puts a unique spin on a piece of content, which then “goes viral” and reaches a large audience.

Amplifier identification module 830 may be configured to identify an amplifier who outsizes impact of the original content. An “amplifier” as the term is used herein, may be someone who reaches a large audience, such as a social media influencer, a famous actor/actress, or other person with a large following.

Rising star identification module 832 may be configured to identify a rising star that participates by seeing a spike in engagement with the original content and follows the original content. A “rising star” is someone who recognizes content before it becomes trendy to do so, and follows that content during its rise from obscurity to trend.

Content tracking module 810 may be configured to track the original content and mutations of the original content across different social media platforms. By way of non-limiting example, attribution of the original content may be assigned based on one or more of a time of creation, a platform the original content was first shared on, and/or a level of confidence that the original content is from the content creator. An assigned attribution of the original content is overridden if misattributed to the content creator.

In some implementations, computing platform(s) 802, remote platform(s) 804, and/or external resources 834 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 802, remote platform(s) 804, and/or external resources 834 may be operatively linked via some other communication media.

A given remote platform 804 may include one or more processors configured to execute computer program modules. The computer program modules may be configured to enable an expert or user associated with the given remote platform 804 to interface with system 800 and/or external resources 834, and/or provide other functionality attributed herein to remote platform(s) 804. By way of non-limiting example, a given remote platform 804 and/or a given computing platform 802 may include one or more of a server, a desktop computer, a laptop computer, a handheld computer, a tablet computing platform, a NetBook, a Smartphone, a gaming console, and/or other computing platforms.

External resources 834 may include sources of information outside of system 800, external entities participating with system 800, and/or other resources. In some implementations, some or all of the functionality attributed herein to external resources 834 may be provided by resources included in system 800.

Computing platform(s) 802 may include electronic storage 836, one or more processors 838, and/or other components. Computing platform(s) 802 may include communication lines, or ports to enable the exchange of information with a network and/or other computing platforms. Illustration of computing platform(s) 802 in FIG. 8 is not intended to be limiting. Computing platform(s) 802 may include a plurality of hardware, software, and/or firmware components operating together to provide the functionality attributed herein to computing platform(s) 802. For example, computing platform(s) 802 may be implemented by a cloud of computing platforms operating together as computing platform(s) 802.

Electronic storage 836 may comprise non-transitory storage media that electronically stores information. The electronic storage media of electronic storage 836 may include one or both of system storage that is provided integrally (i.e., substantially non-removable) with computing platform(s) 802 and/or removable storage that is removably connectable to computing platform(s) 802 via, for example, a port (e.g., a USB port, a firewire port, etc.) or a drive (e.g., a disk drive, etc.). Electronic storage 836 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 836 may include one or more virtual storage resources (e.g., cloud storage, a virtual private network, and/or other virtual storage resources). Electronic storage 836 may store software algorithms, information determined by processor(s) 838, information received from computing platform(s) 802, information received from remote platform(s) 804, and/or other information that enables computing platform(s) 802 to function as described herein.

Processor(s) 838 may be configured to provide information processing capabilities in computing platform(s) 802. As such, processor(s) 838 may include one or more of a digital processor, an analog processor, a digital circuit designed to process information, an analog circuit designed to process information, a state machine, and/or other mechanisms for electronically processing information. Although processor(s) 838 is shown in FIG. 8 as a single entity, this is for illustrative purposes only. In some implementations, processor(s) 838 may include a plurality of processing units. These processing units may be physically located within the same device, or processor(s) 838 may represent processing functionality of a plurality of devices operating in coordination. Processor(s) 838 may be configured to execute modules 808, 810, 812, 814, 816, 818, 820, 822, 824, 826, 828, 830, and/or 832, and/or other modules. Processor(s) 838 may be configured to execute modules 808, 810, 812, 814, 816, 818, 820, 822, 824, 826, 828, 830, and/or 832, and/or other modules by software; hardware; firmware; some combination of software, hardware, and/or firmware; and/or other mechanisms for configuring processing capabilities on processor(s) 838. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 808, 810, 812, 814, 816, 818, 820, 822, 824, 826, 828, 830, and/or 832 are illustrated in FIG. 8 as being implemented within a single processing unit, in implementations in which processor(s) 838 includes multiple processing units, one or more of modules 808, 810, 812, 814, 816, 818, 820, 822, 824, 826, 828, 830, and/or 832 may be implemented remotely from the other modules. The description of the functionality provided by the different modules 808, 810, 812, 814, 816, 818, 820, 822, 824, 826, 828, 830, and/or 832 described below is for illustrative purposes, and is not intended to be limiting, as any of modules 808, 810, 812, 814, 816, 818, 820, 822, 824, 826, 828, 830, and/or 832 may provide more or less functionality than is described. For example, one or more of modules 808, 810, 812, 814, 816, 818, 820, 822, 824, 826, 828, 830, and/or 832 may be eliminated, and some or all of its functionality may be provided by other ones of modules 808, 810, 812, 814, 816, 818, 820, 822, 824, 826, 828, 830, and/or 832. As another example, processor(s) 838 may be configured to execute one or more additional modules that may perform some or all of the functionality attributed below to one of modules 808, 810, 812, 814, 816, 818, 820, 822, 824, 826, 828, 830, and/or 832.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers may be authorization/privacy servers for enforcing privacy settings. In response to a request from a user (or other entity) for a particular object stored in a data store, the social-networking system may send a request to the data store for the object. The request may identify the user associated with the request and the object may be sent only to the user (or a client system of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system may access such information in order to provide a particular function or service to the first user, without the social-networking system having access to that information for any other purposes. Before accessing, storing, or using such objects or information, the social-networking system may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system.

In particular embodiments, a user may specify whether particular types of objects or information associated with the first user may be accessed, stored, or used by the social-networking system. As an example and not by way of limitation, the first user may specify that images sent by the first user through the social-networking system may not be stored by the social-networking system. As another example and not by way of limitation, a first user may specify that messages sent from the first user to a particular second user may not be stored by the social-networking system. As yet another example and not by way of limitation, a first user may specify that all objects sent via a particular application may be saved by the social-networking system.

In particular embodiments, privacy settings may allow a first user to specify whether particular objects or information associated with the first user may be accessed from particular client systems or third-party systems. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system may provide default privacy settings with respect to each device, system, or application, and/or the first user may be prompted to specify a particular privacy setting for each context. As an example and not by way of limitation, the first user may utilize a location-services feature of the social-networking system to provide recommendations for restaurants or other places in proximity to the user. The first user's default privacy settings may specify that the social-networking system may use location information provided from a client device of the first user to provide the location-based services, but that the social-networking system may not store the location information of the first user or provide it to any third-party system. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The social-networking system may determine that this privacy setting also applies to the first image and make the first image visible only to the first user group. In particular embodiments, the change in privacy settings may take effect only going forward. Continuing the example above, if the first user changes privacy settings and then shares a second image, the second image may be visible only to the first user group, but the first image may remain visible to all users. In particular embodiments, in response to a user action to change a privacy setting, the social-networking system may further prompt the user to indicate whether the user wants to apply the changes to the privacy setting retroactively. In particular embodiments, a user change to privacy settings may be a one-off change specific to one object. In particular embodiments, a user change to privacy may be a global change for all objects associated with the user.

In particular embodiments, the social-networking system may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular embodiments, upon determining that a trigger action has occurred, the social-networking system may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social-networking system may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social-networking system may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular embodiments, a user may need to provide verification of a privacy setting on a periodic basis. A prompt or reminder may be periodically sent to the user based either on time elapsed or a number of user actions. As an example and not by way of limitation, the social-networking system may send a reminder to the user to confirm his or her privacy settings every six months or after every ten photo posts. In particular embodiments, privacy settings may also allow users to control access to the objects or information on a per-request basis. As an example and not by way of limitation, the social-networking system may notify the user whenever a third-party system attempts to access information associated with the user, and require the user to provide verification that access should be allowed before proceeding.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

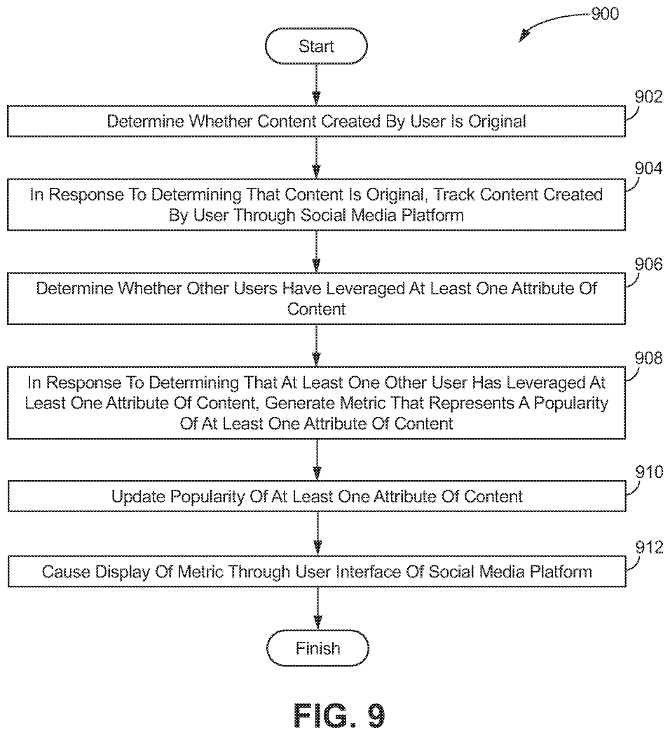

FIG. 9 illustrates an example flow diagram (e.g., process 900) for attribution in social media platforms, according to certain aspects of the disclosure. For explanatory purposes, the example process 900 is described herein with reference to FIGS. 1-8. Further for explanatory purposes, the steps of the example process 900 are described herein as occurring in serial, or linearly. However, multiple instances of the example process 900 may occur in parallel. For purposes of explanation of the subject technology, the process 900 will be discussed in reference to FIGS. 1-8.

At a step 902, the process 900 may include determining whether content created by a user is original. The content may include at least one attribute. The content may be generated through a social media platform. At a step 904, the process 900 may include, in response to determining that the content is original, tracking the content created by the user through the social media platform. At a step 906, the process 900 may include determining whether other users have leveraged the at least one attribute of the content. At a step 908, the process 900 may include, in response to determining that at least one other user has leveraged the at least one attribute of the content, generating a metric that represents a popularity of the at least one attribute of the content. At a step 910, the process 900 may include updating the popularity of the at least one attribute of the content. At a step 912, the process 900 may include causing display of the metric through a user interface of the social media platform.

For example, as described above in relation to FIGS. 1-8, at a step 902, the process 900 may include determining whether content created by a user is original, through original content determination module 808. The content may include at least one attribute. The content may be generated through a social media platform. At a step 904, the process 900 may include, in response to determining that the content is original, tracking the content created by the user through the social media platform, through content tracking module 810. At a step 906, the process 900 may include determining whether other users have leveraged the at least one attribute of the content, through attribute leverage determination module 812. At a step 908, the process 900 may include, in response to determining that at least one other user has leveraged the at least one attribute of the content, generating a metric that represents a popularity of the at least one attribute of the content, through metric generation module 814. At a step 910, the process 900 may include updating the popularity of the at least one attribute of the content, through popularity updating module 816. At a step 912, the process 900 may include causing display of the metric through a user interface of the social media platform, through display causing module 818.

According to an aspect, the process 900 further includes causing display of content that causes a trend in a trend tab.

According to an aspect, the attribute is displayed in a separate tab from the trend tab.

According to an aspect, the attribute comprises at least one of audio, effect, remix, hashtag, and challenge.

According to an aspect, the process 900 further includes receiving a selection of an attribute by the user.

According to an aspect, the process 900 further includes causing display of a pivot page based on the selection, the pivot page displaying trending content that leverages the selected attribute.

According to an aspect, the pivot page comprises a trend timeline.

According to an aspect, the trend timeline comprises trending content.

According to an aspect, the trend timeline displays growth of the attribute.

According to an aspect, the process 900 further includes causing display of one or more of trendsetters, amplifiers, and/or rising stars.

According to an aspect, the trendsetters comprise originators of a trend comprising at least one attribute.

According to an aspect, the amplifiers comprise users that have a large impact on spreading the trend.

According to an aspect, the rising stars comprise small-sized creators.

According to an aspect, the content comprises a media type comprising at least one of a reel, video, story, photo, product, advertisement, or branded content.

According to an aspect, the process 900 further includes generating an NFT based on the attribute.

According to an aspect, the process 900 further includes tracking the popularity of the attribute through a blockchain of the NFT.

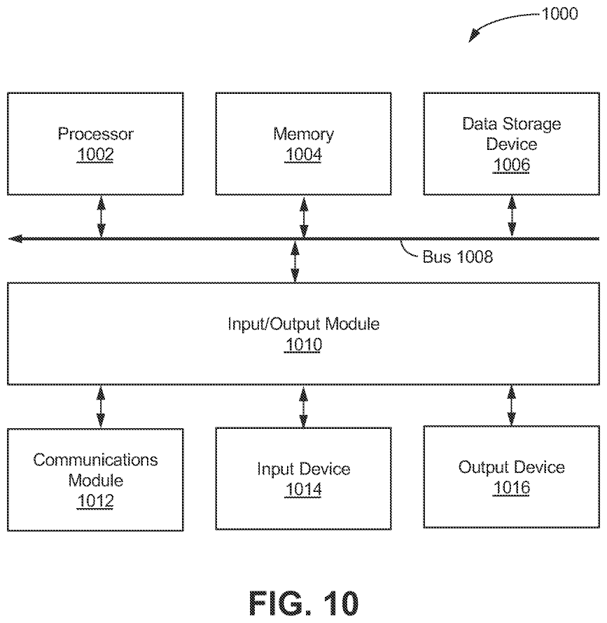

FIG. 10 is a block diagram illustrating an exemplary computer system 1000 with which aspects of the subject technology can be implemented. In certain aspects, the computer system 1000 may be implemented using hardware or a combination of software and hardware, either in a dedicated server, integrated into another entity, or distributed across multiple entities.

Computer system 1000 (e.g., server and/or client) includes a bus 1008 or other communication mechanism for communicating information, and a processor 1002 coupled with bus 1008 for processing information. By way of example, the computer system 1000 may be implemented with one or more processors 1002. Processor 1002 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1000 can include, in addition to hardware, code that creates an execution environment for the computer program in question, e.g., code that constitutes processor firmware, a protocol stack, a database management system, an operating system, or a combination of one or more of them stored in an included memory 1004, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1008 for storing information and instructions to be executed by processor 1002. The processor 1002 and the memory 1004 can be supplemented by, or incorporated in, special purpose logic circuitry.

The instructions may be stored in the memory 1004 and implemented in one or more computer program products, i.e., one or more modules of computer program instructions encoded on a computer-readable medium for execution by, or to control the operation of, the computer system 1000, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1004 may also be used for storing temporary variable or other intermediate information during execution of instructions to be executed by processor 1002.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1000 further includes a data storage device 1006 such as a magnetic disk or optical disk, coupled to bus 1008 for storing information and instructions. Computer system 1000 may be coupled via input/output module 1010 to various devices. The input/output module 1010 can be any input/output module. Exemplary input/output modules 1010 include data ports such as USB ports. The input/output module 1010 is configured to connect to a communications module 1012. Exemplary communications modules 1012 include networking interface cards, such as Ethernet cards and modems. In certain aspects, the input/output module 1010 is configured to connect to a plurality of devices, such as an input device 1014 and/or an output device 1016. Exemplary input devices 1014 include a keyboard and a pointing device, e.g., a mouse or a trackball, by which a user can provide input to the computer system 1000. Other kinds of input devices 1014 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1016 include display devices such as an LCD (liquid crystal display) monitor, for displaying information to the user.

According to one aspect of the present disclosure, the above-described gaming systems can be implemented using a computer system 1000 in response to processor 1002 executing one or more sequences of one or more instructions contained in memory 1004. Such instructions may be read into memory 1004 from another machine-readable medium, such as data storage device 1006. Execution of the sequences of instructions contained in the main memory 1004 causes processor 1002 to perform the process steps described herein. One or more processors in a multi-processing arrangement may also be employed to execute the sequences of instructions contained in memory 1004. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1000 can include clients and servers. A client and server are generally remote from each other and typically interact through a communication network. The relationship of client and server arises by virtue of computer programs running on the respective computers and having a client-server relationship to each other. Computer system 1000 can be, for example, and without limitation, a desktop computer, laptop computer, or tablet computer. Computer system 1000 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1002 for execution. Such a medium may take many forms, including, but not limited to, non-volatile media, volatile media, and transmission media. Non-volatile media include, for example, optical or magnetic disks, such as data storage device 1006. Volatile media include dynamic memory, such as memory 1004. Transmission media include coaxial cables, copper wire, and fiber optics, including the wires that comprise bus 1008. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1000 reads game data and provides a game, information may be read from the game data and stored in a memory device, such as the memory 1004. Additionally, data from the memory 1004 servers accessed via a network the bus 1008, or the data storage 1006 may be read and loaded into the memory 1004. Although data is described as being found in the memory 1004, it will be understood that data does not have to be stored in the memory 1004 and may be stored in other memory accessible to the processor 1002 or distributed among several media, such as the data storage 1006.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for attributing origination to content creators, comprising:
determining whether content created by a user is original, the content comprising at least one attribute, the content generated through a social media platform;
in response to determining that the content is original, tracking the content created by the user through the social media platform;
determining whether other users have leveraged the at least one attribute of the content;
in response to determining that at least one other user has leveraged the at least one attribute of the content, generating a metric that represents a popularity of the at least one attribute of the content;
updating the popularity of the at least one attribute of the content; and
causing display of the metric through a user interface of the social media platform.

2. The computer-implemented method of claim 1, further comprising:
causing display of content that causes a trend in a trend tab.

3. The computer-implemented method of claim 2, wherein the attribute is displayed in a separate tab from the trend tab.

4. The computer-implemented method of claim 1, wherein the attribute comprises at least one of audio, effect, remix, hashtag, and challenge.

5. The computer-implemented method of claim 1, further comprising:
receiving a selection of an attribute by the user; and
causing display of a pivot page based on the selection, the pivot page displaying trending content that leverages the selected attribute.

6. The computer-implemented method of claim 5, wherein the pivot page comprises a trend timeline.

7. The computer-implemented method of claim 6, wherein the trend timeline comprises trending content.

8. The computer-implemented method of claim 6, wherein the trend timeline displays growth of the attribute.

9. The computer-implemented method of claim 1, further comprising:
causing display of one or more of trendsetters, amplifiers, and/or rising stars.

10. The computer-implemented method of claim 9, wherein the trendsetters comprise originators of a trend comprising at least one attribute.

11. A system configured for attributing origination to content creators, comprising:
one or more hardware processors configured by machine-readable instructions to:
determine whether content created by a user is original, the content comprising at least one attribute, the content generated through a social media platform;
in response to determining that the content is original, track the content created by the user through the social media platform;
assigning attribution of the content to the user;
determine whether other users have leveraged the at least one attribute of the content, the at least one attribute tracking the content as the content is leveraged so that origination of the content is attributable back to the user;
in response to determining that at least one other user has leveraged the at least one attribute of the content, generate a metric that represents a popularity of the at least one attribute of the content;
update the popularity of the at least one attribute of the content; and
cause display of the metric through a user interface of the social media platform.

12. The system of claim 11, wherein the one or more hardware processors are further configured by machine-readable instructions to:
cause display of content that causes a trend in a trend tab.

13. The system of claim 12, wherein the attribute is displayed in a separate tab from the trend tab.

14. The system of claim 11, wherein the attribute comprises at least one of audio, effect, remix, hashtag, and challenge.

15. The system of claim 11, wherein the one or more hardware processors are further configured by machine-readable instructions to:
receive a selection of an attribute by the user; and
cause display of a pivot page based on the selection, the pivot page displaying trending content that leverages the selected attribute.

16. The system of claim 15, wherein the pivot page comprises a trend timeline.

17. The system of claim 16, wherein the trend timeline comprises trending content.

18. The system of claim 16, wherein the trend timeline displays growth of the attribute.

19. The system of claim 11, wherein the one or more hardware processors are further configured by machine-readable instructions to:
cause display of one or more of trendsetters, amplifiers, and/or rising stars, wherein the trendsetters comprise originators of a trend comprising at least one attribute.

20. A non-transient computer-readable storage medium having instructions embodied thereon, the instructions being executable by one or more processors to perform a computer-implemented method for attributing origination to content creators, the method comprising:
determining whether content created by a user is original, the content comprising at least one attribute, the content generated through a social media platform;
in response to determining that the content is original, tracking the content created by the user through the social media platform;
assigning attribution of the original content based on determining a level of confidence that the content is from the user;
tracking the content and mutations of the content over time;
tracking different media that the original content and the mutations of the content are used in;
determining whether other users have leveraged the at least one attribute of the content;
in response to determining that at least one other user has leveraged the at least one attribute of the content, generating a metric that represents a popularity of the at least one attribute of the content;
updating the popularity of the at least one attribute of the content; and
causing display of the metric through a user interface of the social media platform.
